(19) United States
(12) Patent Application Publication
(10) Pub. No.: US 2025/0340200 A1
(43) Pub. Date: Nov. 6, 2025

(54) METHOD FOR CONTROLLING A VEHICLE BY CARRYING OUT AT LEAST ONE DRIVING DYNAMICS INTERVENTION

(71) Applicant: ZF CV Systems Global GmbH, Bern (CH)

(72) Inventors: Benjamin Bieber, Wedemark (DE); Jonas Böttcher, Hannover (DE); Klaus Plähn, Seelze (DE); Oliver Wulf, Neustadt (DE)

(21) Appl. No.: 19/267,316

(22) Filed: Jul. 11, 2025

Related U.S. Application Data
(63) Continuation of application No. PCT/EP2024/050033, filed on Jan. 2, 2024.

(30) Foreign Application Priority Data
Jan. 13, 2023 (DE) 10 2023 100 748.3

(51) Int. Cl. B60W 30/02

(52) U.S. Cl. CPC B60W 30/02; B60W 2300/14; B60W 2520/22; B60W 2540/18; B60W 2710/205

(57) ABSTRACT

A method is for controlling a vehicle in a driving situation. The method includes determining a target self-steering gradient of the vehicle for the driving situation; determining an actual steering angle of the vehicle in the driving situation; determining an actual self-steering gradient of the vehicle in the driving situation based on the actual steering angle; determining a target/actual deviation between the target self-steering gradient and the actual self-steering gradient; providing a first limit value for the target/actual deviation; detecting early an instability of the vehicle if the determined target/actual deviation violates the first limit value; and in response to the early detection of an instability of the vehicle: performing at least one vehicle dynamics intervention using at least one vehicle actuator of the vehicle to counteract the instability of the vehicle.

### CROSS-REFERENCE TO RELATED APPLICATIONS

This application is a continuation application of international patent application PCT/EP2024/050033, filed Jan. 2, 2024, designating the United States and claiming priority from German application 10 2023 100 748.3, filed Jan. 13, 2023, and the entire content of both applications is incorporated herein by reference.

### TECHNICAL FIELD

The disclosure relates to a method for controlling a vehicle in a driving situation. Furthermore, the disclosure relates to a driver assistance system, a vehicle and a computer program product.

### BACKGROUND

An experienced professional driver can already judge on the basis of his experience whether a vehicle is behaving in a stability-critical manner. The driving style adopted by an experienced driver matches the given boundary conditions and enables the vehicle to be steered safely. The experience necessary for correctly judging the present situation generally only results after multiple years of practice, however. Based on this experience, an experienced driver correctly assesses the vehicle's behavior and controls the vehicle safely in a given driving situation.

In contrast, an inexperienced driver cannot or can only partially correctly assess the vehicle behavior that is to be expected. Drivers referred to as “virtual drivers”, which control autonomous vehicles or perform partial tasks in the control of autonomous or semi-autonomous vehicles, have not hitherto been able to ensure correct assessment of stability behavior. This involves the risk of a driving style unsuitable for the present vehicle configuration and as a result also an increased risk of accident.

Known stability control systems only stabilize vehicles reactively if the vehicle has already clearly left a state of motion that is considered stable. A stability control system, such as Electronic Stability Control (ESC) in particular, only intervenes to stabilize the movement of the vehicle when an intervention threshold is exceeded. This intervention threshold has been set high for safety reasons in order to prevent the stability control system from intervening incorrectly. For example, ESC is usually only triggered when a driver (human or virtual) of the vehicle notices instability and tries to compensate for this by making jerky steering movements. Conventional stability control systems therefore have the disadvantage that the driver is not supported in solving a driving task to be fulfilled for the driving situation, which usually consists of guiding the vehicle along a specific path (target path). Compared to stable driving, considerably more space is required by the late intervention of a conventional stability control system. Although conventional stability control systems generally control instabilities reliably, there are usually considerable deviations of the vehicle from the planned path. This results in a safety risk, especially if an inexperienced driver recognizes an instability late, tries to compensate for the instability late and thus triggers the stability control system late.

### SUMMARY

There is therefore a need for methods for controlling a vehicle, for vehicle control systems, for vehicles and/or for computer program products that enable the early detection of instabilities, which are preferably cost-effective to implement and/or offer improved safety.

In a first aspect, the disclosure solves the problem via a method for controlling a vehicle in a driving situation, including: determining a target self-steering gradient of the vehicle for the driving situation; determining an actual steering angle of the vehicle in the driving situation; determining an actual self-steering gradient of the vehicle in the driving situation on the basis of the actual steering angle; determining a target/actual deviation between the target self-steering gradient and the actual self-steering gradient; providing a first limit value for the target/actual deviation; early detection of instability of the vehicle if the determined target/actual deviation violates the first limit value; and in response to the early detection of instability of the vehicle: executing at least one driving dynamics intervention using at least one vehicle actuator of the vehicle in order to counteract the instability of the vehicle.

The disclosure is based on the realization that the actual self-steering gradient of the vehicle in the driving situation deviates from a target self-steering gradient in the event of instability. The disclosure makes use of this realization by detecting vehicle instability using at least one target/actual deviation determined from the actual self-steering gradient and the target self-steering gradient. The actual steering angle can be easily determined in the driving situation. Conventional vehicle control systems, which are provided in almost all vehicles today, usually determine the steering angle anyway. It is therefore particularly easy to determine the steering angle in the method on the basis of signals and/or measured variables that are already available on the vehicle. The method is particularly easy to implement. Based on the actual steering angle, the actual self-steering gradient can be determined, wherein, in addition to the actual steering angle, other variables of the vehicle and/or a vehicle movement can also be used for this determination. Vehicle variables may include, in particular, geometric data of the vehicle, such as the wheelbase of the vehicle. Vehicle movement variables are preferably a traveled bend radius and/or a measured lateral acceleration.

A driving situation is an objective description of a situation involving a commercial vehicle that is therefore not subjectively perceived by the driver. The driving situation could be, for example, the commercial vehicle cornering or performing an evasive manoeuvre. The driving situation is preferably a situation in which the lateral dynamics of the vehicle change. However, the driving situation can also involve the vehicle driving straight ahead, in which case the actual self-steering gradient is generally equal to zero and the target/actual deviation is also equal to zero. Early detection based on the actual self-steering gradient and the target self-steering gradient allows instabilities to be identified using variables relating to the current vehicle movement. Detection of a vehicle position and/or environmental monitoring are not necessary, but may be provided additionally.

Self-steering behavior describes the steering properties of a vehicle that are independent of driver influence. The self-steering gradient indicates whether the steering angle must be increased or decreased with increasing lateral acceleration in order to be able to drive the same bend radius. In the context of the present disclosure, the self-steering gradient is the difference between a steering angle gradient relative to the lateral acceleration and a gradient of the Ackermann angle relative to the lateral acceleration. The Ackermann angle is the quotient of a vehicle's wheelbase to the radius of a bend in the road, wherein the wheelbase is the dividend and the radius is the divisor. The self-steering gradient (EG) can be expressed by the following formula, in which ay denotes the lateral acceleration, δ the steering angle and SA the target steering angle:

$$EG = \frac{d δ}{{da}_{y}} - \frac{d {δ}_{A}}{{da}_{y}}$$

In the linear range, the following relationship can also be used, wherein R denotes the radius of the trajectory curve and I denotes the wheelbase of the vehicle:

$$δ = \frac{l}{R} + EG \times {a}_{y}$$

For the target self-steering gradient, the steering angle is equal to a target steering angle, and for the actual self-steering gradient, the steering angle considered is the actual steering angle. The behavior of vehicles can be classified as understeering, neutral and oversteering. In the case of understeer, the self-steering gradient has a value greater than zero. This means that, at a certain lateral acceleration, a steering angle greater than the Ackermann angle must be controlled. In the case of oversteer, however, the self-steering gradient is less than zero. It should be understood that the actual self-steering gradient does not necessarily have to be calculated using the above formula. In particular, the method can also be carried out without knowledge of the radius of the bend traveled and/or without knowledge of the wheelbase. The self-steering gradient does not need to be determined as an absolute value in the method. This means that the actual self-steering gradient can also be determined in relation to the radius of the bend being traveled. Since the radius is substantially identical when determining the actual self-steering gradient and the target self-steering gradient, the target/actual deviation can also be determined without knowing the radius. For example, the actual self-steering gradient and the target self-steering gradient can each be determined relative to the radius or as a function of the radius. The radius is entered identically in such functions, so that knowledge of the radius is not necessary to determine the target/actual deviation.

Early detection of instability in commercial vehicles relates in particular to the ability to use the method to detect instability in commercial vehicles earlier than is possible with conventional stability control systems. Conventional stability control systems, often referred to as Electronic Stability Control (ESC), are reactive systems that are only activated when the commercial vehicle's motion is detected as unstable. Due to fault tolerances, which cannot be set too low for safety reasons, and the limited suitability of the available signals for detecting instabilities, conventional stability control systems react relatively late, resulting in large position deviations between the intended trajectory and the actual trajectory.

The driving dynamics intervention is preferably used to stabilize the commercial vehicle. The purpose of the method according to the disclosure is to improve the accuracy with which the vehicle follows a path intended by the driver. A trajectory can encompass this path, which, for example, a human driver wants to travel with the commercial vehicle. Alternatively, the trajectory can also be a trajectory planned for the commercial vehicle by a virtual driver of a (semi-) autonomous vehicle. The trajectory can be limited to a path to be traveled or, preferably, can also include additional information such as the speed of a vehicle when traveling along the path. In the case of a human driver, the positional accuracy of the commercial vehicle can be improved via the method according to the disclosure, in particular when the driver's intended driving behavior is not achieved due to various influences on the vehicle and the commercial vehicle therefore does not follow the intended trajectory. For example, the vehicle's tendency to understeer can be greatly increased compared to normal driving behavior due to incorrect loading of the vehicle in the present vehicle configuration, so that a steering angle specified by the driver is not sufficient to drive along the intended trajectory. The method can improve the trajectory accuracy in such a way that the vehicle substantially follows the trajectory intended by the driver despite such non-optimal steering input from the driver.

According to a first embodiment, determining the target self-steering gradient of the vehicle for the driving situation includes: determining driving data for at least one analogous driving situation and determining the target self-steering gradient from the driving data. An analogous driving situation for the commercial vehicle is a driving situation that corresponds to the current driving situation at least in terms of vehicle speed and actual steering angle. Preferably, the analogous driving situation can also correspond to the current driving situation in terms of other aspects. For example, and preferably, the analogous driving situation and the driving situation may correspond with regard to ambient temperature, weather conditions, precipitation conditions, a road gradient, and/or a road surface condition. The analogous driving situation is a driving situation in which the dynamic vehicle behavior should be substantially identical to the current driving situation. In particular, when several similar driving situations are considered, historical driving data can be used to predict the commercial vehicle's expected behavior in the current driving situation. This expected driving behavior is represented by the target value. If the actual driving behavior represented by the actual variable deviates from this learned driving behavior, this is an indicator of unstable behavior of the commercial vehicle. For example, an autonomous driving gradient can be determined for an analogous driving situation that is assessed as stable. This self-steering gradient of the analogous driving situation can then be used as the target self-steering gradient for the driving situation to be evaluated. It should be understood that driving data does not have to be collected separately for every instance of early detection. This allows the target self-steering gradient to be selected from a plurality of pre-stored target self-steering gradients. During selection, a self-steering gradient is selected as the target self-steering gradient, which was determined for a driving situation that is analogous to the driving situation for which the early determination is being carried out. The determination of driving data for at least one analogous driving situation may also be omitted.

In an embodiment, the method furthermore includes: determining a yaw rate of the vehicle in the driving situation and/or detecting a lateral acceleration of the vehicle in the driving situation; wherein the determination of an actual self-steering gradient of the vehicle in the driving situation is additionally performed based on the actual steering angle using the determined yaw rate and/or additionally using the determined lateral acceleration. When determining the actual self-steering gradient, only the determined yaw rate or only the determined lateral acceleration can be taken into account in addition to the actual steering angle. However, it is preferable to determine this based on the actual steering angle, the determined yaw rate, and the determined lateral acceleration.

The method preferably furthermore includes: determining at least one geometric characteristic of a current vehicle configuration of the vehicle; wherein the determination of an actual self-steering gradient of the vehicle in the driving situation is additionally performed based on the actual steering angle using the geometric characteristic of the vehicle. The geometric characteristic is in particular a geometric variable that defines the driving dynamics of the vehicle, such as a wheelbase of the vehicle, an axle spacing between axles of the vehicle, a track width of the vehicle, a distance between a rear axle of the vehicle and a coupling point of a trailer, and/or a configuration type of a trailer vehicle (for example, drawbar trailer or center-axle trailer). A configuration type of the trailer vehicle can also be taken into consideration or represented via a geometric characteristic.

In a variant, the driving dynamics intervention at least partially compensates for the instability. In this case, the method can preferably be carried out in such a way that the driver is not aware of the driving dynamics intervention. This reduces the steering angle required and the steering effort required by the driver. The vehicle's handling can then appear particularly safe to a driver. If the driving dynamics intervention compensates for the instability at least partially, the control behavior of the vehicle approaches neutral control behavior with a self-steering gradient of zero. However, it may also be sufficient, for example, that the vehicle behaves substantially as a driver of the vehicle would expect as a result of the driving dynamics intervention. It may be preferable to provide that the driving dynamics intervention additionally compensates, at least partially, for a position deviation of the vehicle from an intended path (target path). The risk of the vehicle colliding with objects next to the path is reduced. The driving dynamics intervention therefore preferably improves the safety of the vehicle not only by counteracting instability, but also by improving the positional accuracy of the vehicle. It may be provided here that the same driving dynamics intervention compensates for the position deviation and counteracts the instability.

Preferably, the method also includes terminating the driving dynamics intervention if the target/actual deviation reaches or falls below a tolerance limit. In the embodiment, the driving dynamics intervention is terminated when the deviation between the actual and target values has been reduced to such an extent that the actual self-steering gradient lies within a tolerance range, the breadth of which is determined by the tolerance limit, around the target self-steering gradient. Alternatively or in addition, the driving dynamics intervention can also be terminated if the position deviation of the vehicle from the intended path reaches or falls below a position tolerance limit.

In an embodiment of the method, providing a first limit value for the target/actual deviation includes: determining at least one load characteristic of the current vehicle configuration; and defining the first limit value for the target/actual deviation using the determined load characteristic. Furthermore, the provision preferably includes determining at least one geometric characteristic of the current vehicle configuration; and defining the first limit value for the target/actual deviation additionally using the determined geometric characteristic. In the preferred development the disclosure makes use of the finding that the transverse dynamic stability behavior of the vehicle is significantly influenced by the present vehicle configuration. In addition to geometric characteristics, load characteristics also have a significant influence on the stability behavior of the vehicle. The load characteristic represents loads acting at least partially on the vehicle, which can result, for example, from the intrinsic weight of the vehicle and from a cargo of the vehicle. Thus, a current vehicle configuration of an unloaded vehicle is different from a current vehicle configuration of the same vehicle in the loaded state. A load characteristic can preferably be or include a wheel load, an axle load, a total vehicle mass, a mass of part of the vehicle and/or a location of a center of mass of the vehicle or of part of the vehicle. Furthermore, the load characteristics can preferably also include data which represent a wheel load, an axle load, a total vehicle mass, and/or a mass of part of the vehicle. By defining the first limit value using the load characteristic, the current vehicle configuration can be taken into account. For example, the first limit value can be defined as comparatively small or narrow if the load characteristic represents a rear-loaded vehicle, which generally tends to become unstable more quickly than a centrally loaded vehicle.

Preferably, the driving dynamics intervention is a braking intervention on one or more brakes of the vehicle, an engine torque limitation of an engine of the vehicle, a provision of asymmetrical drive torques on wheels of the vehicle and/or a provision of an assisting steering torque via a steerable auxiliary axle of the vehicle. Preferably, the driving dynamics intervention is carried out using a vehicle actuator that is different from a steering system of the vehicle on which the actual steering angle is set in the driving situation.

In an embodiment, when instability of the vehicle is detected at an early stage, it is determined whether the instability is understeer or oversteer of the vehicle in the driving situation. Preferably, the driving dynamics intervention is a braking intervention on one or more wheels of the vehicle on the inside of the bend if the instability is understeer, and a braking intervention on a wheel on the outside of the bend, in particular the front wheel on the outside of the bend, if the instability is oversteer. Understeer can be detected if the determined actual self-steering gradient is positive, and oversteer can be detected if the determined actual self-steering gradient is negative. It may also be provided that understeer is detected if the determined actual self-steering gradient exceeds a predefined reference value. Similarly, oversteer can be detected if the determined actual self-steering gradient falls below the predefined reference value. This is particularly desirable because modern vehicles are generally configured to understeer, meaning that a reference value for the self-steering gradient is usually greater than zero.

The method preferably further includes: determining a steering oscillation using a time history of the actual steering angle; and in response to detecting a steering oscillation: reducing the first limit value if a steering oscillation is determined that lies within a natural frequency band of the vehicle. Preferably, the method includes determining the natural frequency band, which is particularly preferably based on a vehicle model of the vehicle. In cases where there is a steering oscillation on the vehicle that lies within a natural frequency band around a natural frequency of the vehicle, there is a risk that the steering oscillation or the resulting excitation of the vehicle will lead to a resonance of the vehicle. In this case, it is advantageous to lower the first limit value or reduce the limit value. By reducing the first limit value, even small deviations in the target/actual deviations lead to early detection of instability. For example, instability with a reduced first limit value can already be detected with a target/actual deviation of up to 0.003, whereas only a target/actual deviation with a value of 0.006 leads to early detection of instability if no steering oscillation is detected or the detected steering oscillation is not within the natural frequency band of the vehicle.

In one preferred development, the method includes: determining an actual articulation angle between a towing vehicle and a trailer vehicle of the vehicle; determining a target articulation angle for the driving situation; and reducing the first limit value if the actual articulation angle exceeds the target articulation angle by an articulation angle tolerance value. A target articulation angle is preferably determined using a vehicle model, in particular a single-track model of the vehicle. The vehicle model can include one or more load characteristics and one or more geometric characteristics of the vehicle. An actual articulation angle that exceeds the target articulation angle for a driving situation is a strong indication that the trailer vehicle is unstable. For example, the articulation angle can be used to determine whether the trailer vehicle is shunting, also known as jackknifing, or whether the trailer is breaking away. Both are very critical and dangerous situations that can be detected at an early stage by determining the actual articulation angle, which is preferably permanently compared with the target articulation angle, which is preferably determined on the basis of a model calculation. If, for example, the trailer vehicle is empty and the towing vehicle is loaded in such a driving situation, it is very likely that the driver of the towing vehicle will not notice anything because the towing vehicle remains completely stable. In the preferred development, the safety of the method can be improved, as even relatively small target/actual deviations lead to early detection of instability.

The method preferably furthermore includes: determining a current vehicle speed of the vehicle in the driving situation, wherein providing a first limit value for the target/actual deviation includes defining the first limit value at least using the determined vehicle speed, wherein the first limit value is preferably indirectly proportional or inversely proportional to the vehicle speed. At high vehicle speeds, instabilities can quickly lead to significant deviations in the vehicle position, meaning that instabilities should be detected early, especially at high vehicle speeds. Early detection can be improved by defining the first limit value using the determined vehicle speed. However, it may also be stipulated, for example, that early detection only takes place when the vehicle is traveling at a certain minimum speed.

In a second aspect, the disclosure solves the problem mentioned at the outset with a driver assistance system for improving a trajectory orientation of a vehicle, which is configured to carry out the method according to the first aspect of the disclosure. The driver assistance system preferably includes a control unit. Preferably, the driver assistance system further includes an interface that can be connected to a vehicle network of the vehicle. The interface is preferably configured to receive vehicle signals that represent at least the load characteristic, the trajectory, the expected steering angle value, the target self-steering gradient, the vehicle speed and/or the steering angle actual value. It should be understood that one or more of the determination steps of the method may be performed by the driver assistance system on the basis of such vehicle signals. The driver assistance system therefore does not have to determine the load characteristics directly itself, but can also determine them on the basis of load signals provided, for example, by the vehicle's air suspension system on the vehicle network.

In a third aspect, the disclosure solves the problem mentioned at the outset by a vehicle having at least one vehicle actuator and a driver assistance system according to the second aspect of the disclosure. Preferably, the vehicle includes at least two axles and/or a steering system.

According to a fourth aspect of the disclosure, the problem mentioned at the outset is solved via a computer program product which has program code means which are stored on a computer-readable data carrier in order to carry out the method according to the first aspect of the disclosure when the computer program product is executed on a computing unit, in particular the control unit of the driver assistance system according to the second aspect of the disclosure.

It should be understood that the driver assistance system according to the second aspect of the disclosure, the vehicle according to the third aspect of the disclosure and the computer program product according to the fourth aspect of the disclosure have the same and similar sub-aspects as relating to the method according to the first aspect of the disclosure.

### BRIEF DESCRIPTION OF DRAWINGS

The invention will now be described with reference to the drawings wherein:

FIG. 1 is a plan view of a schematically depicted vehicle;

FIG. 2A shows a driving situation of the vehicle illustrated as cornering according to FIG. 1, with the vehicle understeering;

FIG. 2B shows a driving situation of the vehicle according to FIG. 1, illustrated as cornering, with the vehicle oversteering;

FIG. 3 shows a schematic flow chart of a method for controlling the vehicle;

FIG. 4 shows a graph illustrating, for a driving situation, a progression of an actual self-steering gradient, a target self-steering gradient, an actual steering angle, and a lateral acceleration of the vehicle; and,

FIG. 5 shows a graph illustrating, for a driving situation, a progression of an actual steering angle that must be specified when a driving dynamics intervention is present on the vehicle, and a reference progression of the actual steering angle without driving dynamics intervention.

### DETAILED DESCRIPTION

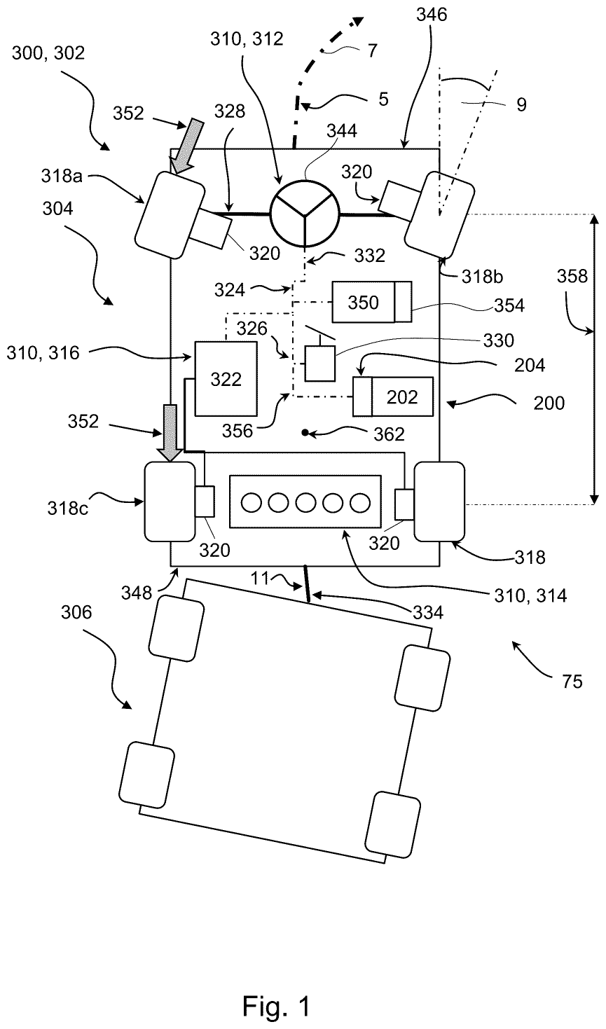

FIG. 1 shows a vehicle 300, which is configured here as a vehicle train 302. The vehicle train 302, which is a commercial vehicle, includes a towing vehicle 304 towing a trailer vehicle 306. The vehicle 300 includes as vehicle actuators 310 an electronically controllable steering system 312, a drive motor 314 and a braking system 316. As an alternative to an electronically controllable steering system 312, a conventional steering system with a steering angle sensor may also be provided. The braking system 316 is provided for decelerating wheels 318 of the vehicle 300. For this purpose, the brake system 316 has brake actuators 320 assigned to the wheels 318. The brake actuators 320 are sub-actuators of the vehicle actuator 310 formed by the brake system 316 and are configured to control a brake slip of one or more of the wheels 318. This brake slip corresponds to a brake pressure provided at the brake actuators 320, which is provided by a brake modulator 322 of the brake system 316. In the embodiment shown, the brake system 316 is a partially electronic brake system 316 that is configured to receive electrical brake signals 326 and to brake the wheels 318 of the vehicle 300 in accordance with the brake signals 326 or via the brake actuators 320 on the wheels 318. To receive the brake signals 326, the brake modulator 322 is connected here to a vehicle network 324. In the embodiment shown, the vehicle network 324 is a CAN bus of the vehicle 300, in particular an ISO 11992 CAN bus. The brake signals 326 are provided by an electronic foot brake module 330 of the vehicle 300 on the vehicle network 324. By pressing the electronic foot brake module 330, a human driver of the vehicle 300 can request braking of the vehicle 300, wherein the brake pressure controlled based on the brake signals 326 corresponds to a travel distance of the electronic foot brake module 330. It should be understood that the brake pressures provided for the different wheels 318 may vary. A brake pressure at a left front wheel 318a of a front axle 328 of the vehicle 300 may therefore be different from a brake pressure provided at the brake actuator 320 associated with a right front wheel 318b of the vehicle 300. Furthermore, the brake system 316 is also provided for decelerating the trailer vehicle 306, wherein only brake actuators 320 of the towing vehicle 304 are shown in FIG. 1.

The driver of the vehicle 300 controls the vehicle 300 in a regular driving situation along an intended path 5. For this purpose, the driver controls the drive motor 314, the braking system 316 and the electronically controllable steering system 312 such that the vehicle 300 follows the intended path 5 as exactly as possible at a target speed 7, wherein the target speed 7 may vary along the path 5 or may represent a speed profile. In addition to the braking system 316 and the foot brake module 330, the vehicle network 324 also interconnects the electronically controllable steering system 312 and an engine control unit of the drive engine 314, which is not shown in FIG. 1. To control the vehicle 300, the driver uses the electronically controllable steering system 312 to set an actual steering angle 9 at the steered wheels of the vehicle 300, which in this case are the front wheels 318a, 318b of the vehicle 300. To do this, the driver sets a steering wheel angle on a steering wheel 344 of the steering system 312, which is then detected by a steering wheel sensor. The steering wheel sensor provides steering signals 332 corresponding to the steering wheel angle to a servomotor of the steering system 312, which in turn provides a steering torque corresponding to the steering signals 332 or to the steering wheel angle to a steering column. The steering column is turned and an actual steering angle 9 corresponding to the steering wheel angle is controlled at the wheels via a steering gear and tie rods. For clarity, the steering wheel sensor, the servomotor, the steering gear, and the tie rods are not shown in FIG. 1. The steering system 312 also sends the steering signals 332 to the vehicle network 324.

The towing vehicle 304 and the trailer vehicle 306 are connected via a drawbar 334, wherein the trailer vehicle 306 here does not include its own drive and is pulled by the towing vehicle 304. The trailer vehicle 306 follows the towing vehicle 304, wherein an actual articulation angle 11 is established between the towing vehicle 304 and the trailer vehicle 306. When traveling in a stationary straight line, the actual articulation angle 11 has a value of 0°, since the trailer vehicle 306 is traveling straight behind the towing vehicle 304.

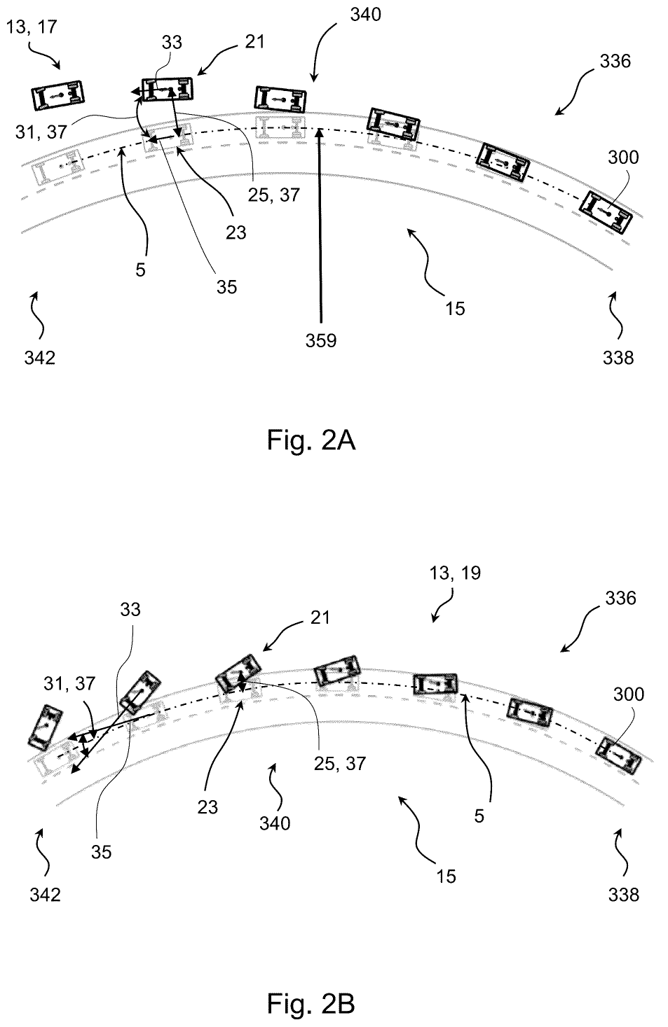

In the present embodiment, during normal driving, the human driver alone controls the vehicle 300 shown in FIG. 1. However, it may also be provided that the vehicle is an autonomous vehicle that can be controlled, at least in part, by an autonomous unit, also referred to as a virtual driver. In certain driving situations, the vehicle 300 may become unstable and not behave as the driver expects. This is often the case if the vehicle 300 is loaded unfavorably. An unfavorable load is present, for example, if the trailer vehicle 306 is fully loaded while the towing vehicle 304 is empty. In this case, the vehicle 300 tends to be unstable, as the trailer vehicle 306 can push the towing vehicle 304 from behind. Furthermore, a deviation between the assumed driving behavior and a real driving behavior can exist, for example, if a loading situation of a trailer vehicle 306 configured as a semitrailer leads to an increased rear axle load of a towing vehicle 304 configured as a tractor unit and thus causes understeering driving behavior. Furthermore, poor road conditions, such as slippery roads or reduced friction between the wheels 318 of the vehicle 300 and a road surface 334 (see FIGS. 2A, 2B) due to an oil slick, sand or chippings, can result in the vehicle 300 being unable to follow the intended path 5.

Two types of instability 13 that can occur in a driving situation 15 are understeer 17 and oversteer 19 of the vehicle 300. FIG. 2A and FIG. 2B illustrate the driving situation 15 as a cornering movement of the vehicle 300, wherein only the towing vehicle 304 is shown for simplification. FIG. 2A shows understeer 17 of the vehicle 300, while FIG. 2B illustrates oversteer 19 of the vehicle 300. In FIG. 2A and FIG. 2B, the instability 13 (understeer 17 or oversteer 19) is superimposed on a stable driving state in which the vehicle 300 ideally follows the path 5 intended by the driver. The vehicle 300 ideally following the path 5 is shown in FIG. 2A and FIG. 2B with a lower contrast. When entering the bend 336 shown, a vehicle position 21 of the vehicle 300 is still substantially identical to a target position 23 of the vehicle 300 on the path 5 when the instability 13 is present.

In FIG. 2A, the vehicle 300 travels through the bend 336 from right to left. A bend entry 338 is thus shown near the right edge of the image, while a bend exit 342 is arranged near the left edge of the image. A bend apex 340 of the bend 336 lies between the bend entry 338 and the bend exit 342. In the unstable case, the vehicle 300 cannot follow the course of the bend 336, which in this case corresponds to the intended path 5. In the case of understeer 17, the vehicle 300 deviates from the path 5 toward the outside of the bend. A lateral deviation 25 of the vehicle 300 relative to the path 5 increases continuously from the bend entry 338 to the bend exit 342. An actual yaw rate of the vehicle 300 is lower than a target yaw rate, so that the vehicle 300 does not turn sufficiently enough into the bend 336 to follow the path 5. A directional error 31 between an actual alignment 33 of the vehicle 300 in the vehicle position 21 and a target alignment 35 of the stably moving vehicle 300 also increases towards the bend exit 340. In the embodiment shown, a multidimensional position deviation 37 between the vehicle position 21 and the path 5 therefore occurs during cornering. On the one hand, the vehicle position 21 in the form of the lateral deviation 25 deviates from the target position 23 transversely to a direction of travel and, on the other hand, the actual alignment 33 of the vehicle position 21 differs from the target alignment 35.

FIG. 2B illustrates an oversteering vehicle 300. When oversteering 19 occurs, the vehicle 300 turns in more than would be necessary to follow the path 5. Even though the actual steering angle 9 of the vehicle 300 is smaller than a target steering angle required for stable driving, the actual yaw rate of the vehicle 300 exceeds the target yaw rate during oversteering 19. The directional error 31 also increases continuously during oversteer 19 from bend entry 338 to bend exit 342, but has a different sign compared to understeer 17. Thus, a front 346 of the vehicle 300 points further inwards into the bend when oversteering 19 than when the vehicle 300 is driving stably, whereas the front 346 of the vehicle 300 points further outwards into the bend when understeering 17 than when the vehicle 300 is driving stably. Due to the excessive actual yaw rate compared to the target yaw rate, a rear 348 of the vehicle 300 breaks away during oversteer 19. In the embodiment shown in FIG. 2B, a lateral deviation 25 of the vehicle 300 also increases towards the outside of the bend.

In extreme cases, the driver keeps the actual steering angle 9 constant and does not adapt it to the driving situation 15 despite the presence of the position deviation 37. However, the human driver usually monitors the vehicle position 21 of the vehicle 300 substantially continuously. As soon as the driver detects a noticeable position deviation 37, he attempts to return the vehicle 300 to the intended path 5 by taking appropriate control measures. However, the driver does not quite fully manage this here. In the event of understeer 17 (see FIG. 2A), a human driver generally increases the actual steering angle 9 all the faster the greater the lateral deviation 25 of the vehicle 300. As soon as this adjustment of the actual steering angle 9 by the driver exceeds a predefined rate of change (a predefined steering angle gradient), a stability control system 350 of the vehicle 300 intervenes to stabilize it. The stability control system 350 here is an Electronic Stability Control (ESC), which is connected to the vehicle network 324 (see FIG. 1). The ESC provides brake signals 326 on the vehicle network 324 that cause the braking system 316 of the vehicle 300 to apply brake pressure to the brake actuators 320 associated with the inside wheels of the vehicle 300. The brake actuators therefore decelerate the wheels on the inside of the bend. For the bend 336 according to FIG. 2A, the wheels on the inside of the bend are a left front wheel 318a and a left rear wheel 318c of the vehicle 300. The delay is illustrated by arrows 352 in FIG. 1. In the case of oversteer 19 (see FIG. 2B), on the other hand, a front wheel on the outside of the bend, which for the left-hand bend 336 according to FIG. 2B is a right-hand front wheel 318b of the vehicle, is preferably decelerated.

The stability control system 350 is an emergency system that only intervenes in the driving operation of the vehicle 300 when very large instabilities 13 occur. ESC interventions in stable driving conditions must be avoided, as these would significantly impair the safety of the vehicle 300 and could lead to accidents. An intervention threshold of the stability control system 350 is therefore selected so high that only major instabilities 13 of the vehicle 300 or large steering angle gradients caused in response to major instabilities 13 lead to an intervention of the stability control system 350 (ESC). The high intervention thresholds of the stability control system 350 mean that the stability control system 350 only intervenes at a late stage, usually only when the vehicle 300 already has a very large lateral deviation 25 from the path 5. The late intervention of the stability control system 350 therefore entails the risk that the vehicle 300 may leave the road 334 and/or collide with an obstacle, in particular the oncoming traffic, due to the increased space required. The stability control system 350 also intervenes late in the event of oversteer 19, as incorrect interventions, which can result from measurement errors for example, must be avoided. Unless another system is provided, it is the driver's responsibility to recognize instability 13 at an early stage, which is a major challenge, especially for inexperienced drivers.

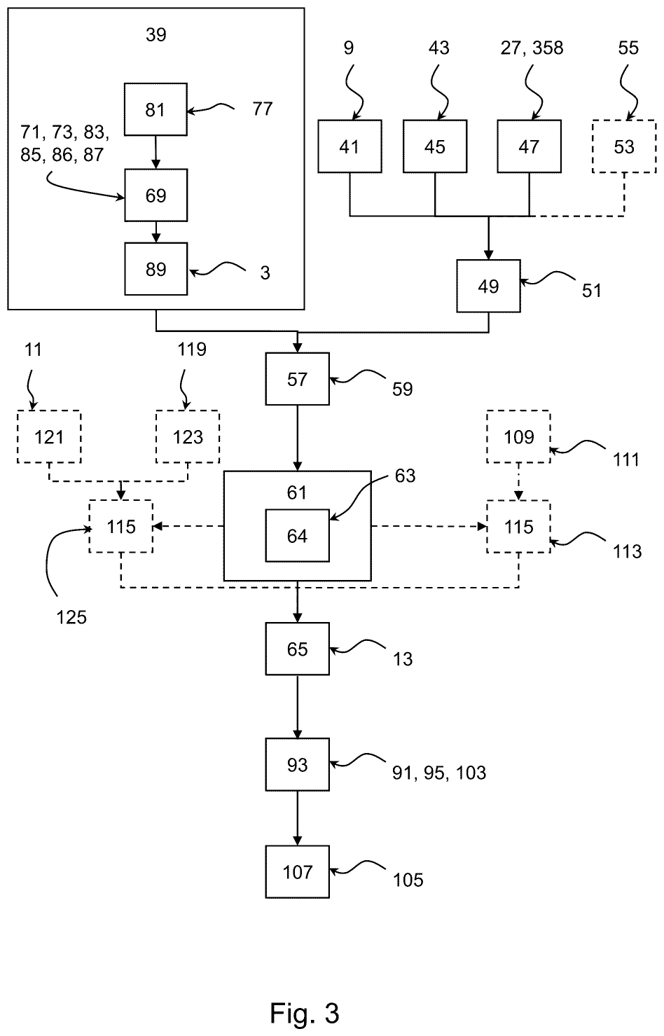

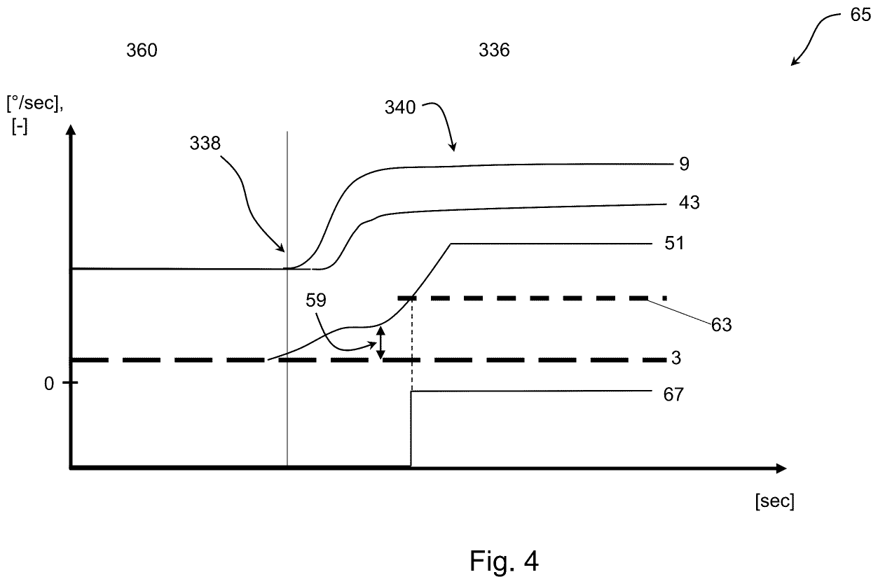

The vehicle 300 therefore additionally includes a driver assistance system 200, which is intended for the early detection of instability 13. The driver assistance system 200 has a control unit 202, which is connected to the vehicle network 324 via an interface 204. The control unit 202 is configured to provide braking signals 326 for the braking system 316 and steering signals 332 on the vehicle network 324. The vehicle 300 can therefore be controlled not only by the human driver, but also, if necessary, at least partially by the driver assistance system 200. The driver assistance system 200 is configured to carry out the vehicle control method 1 explained below with reference to FIG. 3 and FIG. 4.

In a first step of the method 1, the driver assistance system 200 determines a target self-steering gradient 3 of the vehicle 300 for the driving situation 15 as part of a determination 39. This determination 39 of the target self-steering gradient 3 will be explained in more detail later.

In the driving situation 15, the driver controls the vehicle 300 using the steering wheel 344. In the driving situation 15, or while the vehicle 300 is driving through the bend 336 in the embodiment shown in FIG. 2A, the actual steering angle 9 is controlled at the steered front wheels 318a, 318b of the vehicle 300. The control unit 202 receives the steering signals 332 provided by the steering wheel angle sensor on the vehicle network 324 and uses them to determine 41 the actual steering angle 9 actually controlled in the driving situation 15.

The stability control system 350 of the vehicle 300 continuously monitors the movement of the vehicle 300. For this purpose, the stability control system 350 has an acceleration sensor 354 that is configured to measure the lateral acceleration 43 of the vehicle 300. The stability control system 350 provides corresponding lateral acceleration signals 356 on the vehicle network for lateral acceleration 43. The driver assistance system 200 receives the lateral acceleration signals 356 from the vehicle network 324 and, based on these, performs a detection 45 of the lateral acceleration 43 of the driving situation 15. The detected lateral acceleration 43 in the present embodiment is therefore a lateral acceleration 43 or a temporal progression of the lateral acceleration 43 acting on the vehicle 300 when passing through the bend 336.

In a further step of the method 1, the control unit 202 of the driver assistance system 200 performs a determination 47 of a geometric characteristic 27 of a current vehicle configuration 75 of the vehicle 300. The geometric characteristic 27 in this embodiment is a wheelbase 358 of the vehicle 300 shown in FIG. 1. The geometric characteristic 27 can be determined 47 based on signals provided, for example, by a main control unit (not shown) on the vehicle network 324. However, in this case, the wheelbase 357 is stored in a memory of the control unit 202 that is not shown and is determined by accessing the memory. In the present embodiment, determining 41 the actual steering angle 9, detecting 45 the lateral acceleration 43, and determining 47 the wheelbase 358 are performed before determining 39 the target self-steering gradient 3. However, it should be understood that one or more of the determination steps may also be performed after or simultaneously with the determination 39 of the target self-steering gradient 3.

The control unit 202 of the driver assistance system then uses the determined actual steering angle 9, the determined lateral acceleration 43, and the determined wheelbase 358 to determine 49 an actual self-steering gradient 51. In the present embodiment, the control unit 202 determines the actual self-steering gradient 51 as a relative value with reference to a radius 359 of the bend 336 (FIG. 2A). In variants, the method 1 further includes determining 53 a yaw rate 55 of the vehicle 300 in the driving situation 15, wherein the determination 49 of the actual self-steering gradient 51 is then additionally performed using the determined yaw rate 55. The determination 53 of the yaw rate 55 is indicated in FIG. 3 by dashed lines. The control unit 202 then uses the actual self-steering gradient 51 and the target self-steering gradient 3 obtained previously during the determination 39 to determine 57 a target/actual deviation 59, which is calculated here as the difference between the target self-steering gradient 3 and the actual self-steering gradient 51.

In a further step of the method 1, a first limit value 63 for the target/actual deviation 59 is provided 61. The control unit 202 then uses the first limit value 63 and the actual/target deviation 59 in the event of early detection 65 of instability 13. During early detection 65, the control unit 202 detects an instability 13 when the value of the target/actual deviation 59 violates the first limit value 63. If, for example, a target/actual deviation of 59 with a value of 0.1 is determined here, then an instability 13 is determined for a first limit value 63 of 0.05. The control unit 202 is also configured to determine a type of instability 13 during early detection 65. For a negative target/actual deviation 59, the control unit 202 determines understeer 17, since the actual self-steering gradient 51 in this case is greater than the target self-steering gradient 3 for stable driving of the vehicle 300. Similarly, the control unit 202 detects oversteer 19 if the target/actual deviation 59 has a positive value.

FIG. 4 illustrates the early detection 65 of understeer 17 based on a time progression of the target self-steering gradient 39, the actual self-steering gradient 51, the actual steering angle 9, and the lateral acceleration 43. The time progression describes the driving situation 15 in which the vehicle 300 first travels along a straight section of road 360 and then enters the bend 336. There is no steering on the straight section 360, so the actual steering angle 9 has a value of zero. The actual self-steering gradient 51 is not determined in the straight section 360, and the target self-steering gradient has a constant value. When entering the bend 336, the driver of the vehicle 300 sets an actual steering angle 9 at the steering system 314 that the driver considers appropriate for driving through the bend 336. Starting from the bend entry 338, the actual steering angle 9 initially increases and is then kept substantially constant by the driver, which is indicated by the largely horizontal course of the actual steering angle 9. With a slight time delay, the control of the actual steering angle 9 at the front wheels 318a, 318b of the vehicle 300 causes the vehicle 300 to turn into the bend 336, so that the lateral acceleration 43 at the bend entry 338 initially increases and then remains substantially constant. However, in the case illustrated in FIG. 4, the driver misjudges the driving situation 15 and does not steer sharply enough or steers too little, resulting in an actual steering angle 9 that is too small. The actual steering angle is therefore insufficient to steer the vehicle 300 along the path 5, as the vehicle 300 tends to understeer 17 here. Since the driver maintains the actual steering angle 9 at a familiar level, no control system intervention by the stability control system 350 is initiated, even though the desired yaw rate of the vehicle 300 is not achieved. From the start of the bend 338, the control unit 202 determines the actual self-steering gradient 51. In the present case, this increases over time. This is due to the fact that the understeering behavior of the vehicle 300 results in a lower yaw rate 55 for the vehicle 300 than expected. The set actual steering angle 9 causes the vehicle 300 to yaw less than expected about its vertical axis. As a result, the lateral acceleration 43 acting on the vehicle 300 is also lower than expected and the actual self-steering gradient 51 increases. In the area of the bend apex 340, the actual self-steering gradient 51 then remains at a constant value. The target self-steering gradient 3 does not change with the same bend radius and the same lateral acceleration 43 of the vehicle 300, so that the target/actual deviation 59 between the target self-steering gradient 3 and the actual self-steering gradient 51 also increases starting from the bend entry 338. As soon as the target/actual deviation 59 violates the first limit value 63, an instability 13 is detected at an early point. Early detection 65 is indicated in FIG. 4 by a sudden rise in the flank of an indicator 67. Early detection 65 also involves determining the type of instability 13. For the progression shown in FIG. 4, understeer 17 is detected because the determined actual self-steering gradient 51 has a positive value (that is, is greater than zero). The advantage of the described early detection 65 is that it can be carried out based solely on characteristic variables of the vehicle movement.

The target self-steering gradient 3 can be provided in the method 1 by another unit of the vehicle 300 on the vehicle network 324 and then determined by the control unit 202. Preferably, however, the target self-steering gradient 3 is determined 39 by the control unit 202 itself. In the method 1 illustrated in FIG. 3, the determination 39 of the target self-steering gradient 3 initially includes a determination 69 of driving data 71 of an analogous driving situation 73. In a first step, the control unit 202 of the driver assistance system 200 detects a current vehicle speed 77 (determination 81 in FIG. 3). The actual steering angle 9 is already available as a result of the determination 41. When determining 69 driving data 71, the control unit 202 determines a reference transverse acceleration 85 of the vehicle 300 in the analogous driving situation 73. In the present embodiment, the analogous driving situation 73 is a reference driving situation that precedes driving situation 15 in time, wherein a reference steering angle 83 lies within a steering angle tolerance around the determined actual steering angle 9 and a reference speed 86 lies within a speed tolerance around the determined vehicle speed 77. Furthermore, the analogous driving situation 73 here is a reference driving situation of the same vehicle 300 that occurred in the past. For this analogous driving situation 73, the target self-steering gradient 3 is then determined from the driving data 71 (determination 89 in FIG. 3). The target self-steering gradient 3 can be represented directly by the driving data 71 or part of the driving data 71. However, it may also be provided that the target self-steering gradient 3 is determined using the reference steering angle 83, the reference lateral acceleration 85, a reference yaw rate 87 and/or other variables included in the driving data 71.

Without additional intervention by the driver assistance system 200, the vehicle position 21 of the vehicle 300 deviates further and further from the intended path 5 during the course of the bend 336. Safe operation of the vehicle 300 is at risk. The control unit 202 is therefore configured to execute a driving dynamics intervention 91 (execution 93 in FIG. 3) in response to the early detection 65 of the instability 13 (of the understeer 17 in FIG. 2A). The driving dynamics intervention 91 is a braking intervention 95 in the present embodiment. During the braking intervention 95, the wheels of the vehicle 300 on the inside of the bend (wheels 318a, 318c in FIG. 1) are braked for understeer 17. To this end, the control unit 202 of the driver assistance system 200 provides corresponding braking signals 326 on the vehicle network 324. The brake modulator 322 then controls a brake slip on the wheels 318 on the inside of the bend via the brake actuators 320. The braking intervention 95 can be illustrated analogously to a control system intervention of the stability control system 350 by the arrows 352, but occurs at smaller slip angles at the front wheels 318a, 318b (understeer) or the rear wheels 318c, 318d (oversteer). The braking intervention 95 or the resulting deceleration of the wheels 318 on the inside of the bend causes a yaw moment 55 of the vehicle 300 in the direction of the bend 336.

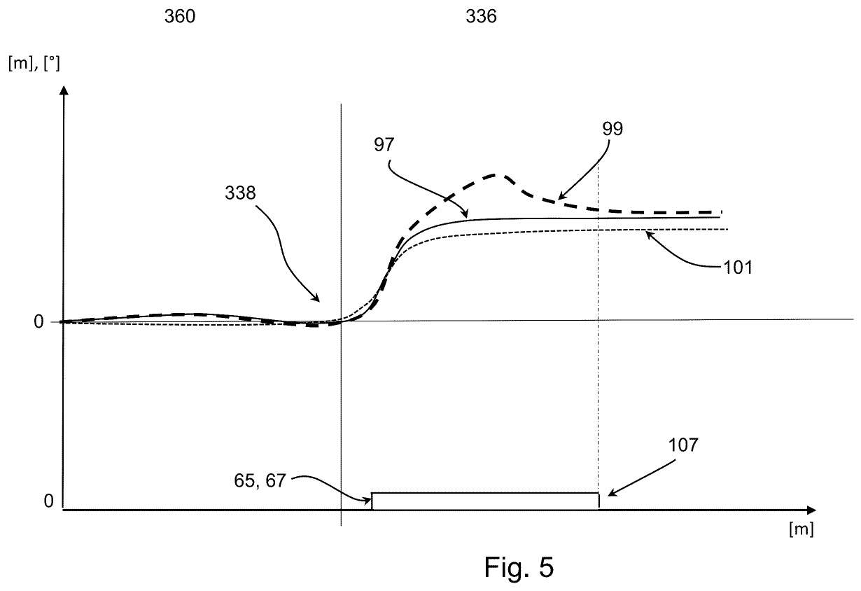

FIG. 5 illustrates a progression 97 of the actual steering angle 9 along the path 5, wherein the control unit 202 performs the driving dynamics intervention 91. For comparison, FIG. 5 shows a reference progression 99 of the actual steering angle 9 without stabilizing braking intervention 95. The progression 97 illustrates that the actual steering angle 9 can be brought close to a kinematic steering angle 101 by the brake application 95 and the resulting additional yaw moment 55. The kinematic steering angle 101 is the steering angle of a neutrally controlled vehicle 300, that is, a vehicle 300 that neither understeers nor oversteers, for the bend 336. In contrast, the actual steering angle 9 must be increased considerably more without stabilizing driving dynamics intervention 91 in order to guide the vehicle 300 safely along the path 5. The driving dynamics intervention 91 compensates for an actual steering angle 9 that is selected too small by the driver of the vehicle 300, thereby increasing safety. For example, space requirements can be reduced and the risk of collisions minimized. Furthermore, in addition to or as an alternative to the braking intervention 95, an engine torque limitation 103 can be carried out, in which an engine torque that can be provided by the drive motor 314 of the vehicle 300 is limited. The motor torque limitation 103 allows the speed of the vehicle 300 to be reduced.

As soon as the target/actual deviation 59 reaches or falls below a tolerance limit 105, the control unit 202 terminates the driving dynamics intervention 91 (termination 107 in FIG. 3). This is the case, for example, when the vehicle 300 leaves the bend 336 at the bend exit 342 and the human driver reduces the actual steering angle 9 or steers the vehicle 300 straight ahead.

In the method 1, the first limit value 63 is selected so that instability 13 is detected reliably and at an early stage. The first limit value 63 is available after the provision 65, wherein the first limit value 63 is defined during the provision 65 using a previously determined load characteristic 69 (defining 64 in FIG. 3). This can be used directly with the early detection 65 of instability 13. In various embodiments, however, it can also be provided that the first limit value 63 is adjusted depending on other parameters before it is compared with the target/actual deviation 59 during early detection 65 of an instability 13. In the embodiment shown in FIG. 3, a steering oscillation 111 is determined 109 for this purpose. The control unit 202 of the driver assistance system 200 monitors the actual steering angle 9 over time to this end. If the determined steering oscillation 111 is within a natural frequency band 113 of the vehicle 300, the control unit 202 executes a reduction 115 of the first limit value 63. The first limit value 63 is reduced during the reduction 115 so that instability 13 is detected earlier. The natural frequency band 113 is preferably determined by the control unit 202 based on a vehicle model. When modeling dynamic properties of the vehicle 300, the control unit may preferably also take into account geometric characteristics 27 and/or one or more load characteristics 79 of the vehicle 300.

The first limit value 63 can further be reduced (reduction 117 in FIG. 3) if the actual articulation angle 11 exceeds a target articulation angle 119 by an articulation angle tolerance value 125. The actual articulation angle 11 and the target articulation angle 119 are determined in advance for this purpose. To determine 121 the actual articulation angle 11, the control unit 202 uses articulation angle signals provided by an articulation angle sensor on the vehicle network 324, which is not shown in the figures. A determination 123 of the target articulation angle 119 is also carried out by the control unit 202, wherein this utilizes dynamic properties of the vehicle 300 determined on the basis of a vehicle model. The optional steps of reduction 115 following steering oscillation 111 and reduction 117 following an impermissible actual articulation angle 11 are illustrated by dashed lines in FIG. 3. After the reduction 115 and the reduction 117, the first limit value 63 is used for early determination 65. Instabilities 13 of the vehicle 300 can thus be detected even earlier in particularly critical driving situations 15.

The method 1 was explained above by way of illustration using the control unit 202 of the driver assistance system 200. However, it should be understood that the method 1 need not be performed by the control unit 202. In particular, the method 1 or individual steps of the method 1 may also be performed by the autonomous unit of the vehicle 300, a main control unit of the vehicle 300 or a steering control unit of the steering system 312.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Method
3 Target self-steering gradient
5 Intended path
7 Target speed
9 Actual steering angle
11 Actual articulation angle
13 Instability
15 Driving situation
17 Understeer
19 Oversteer
21 Vehicle position
23 Target position
25 Lateral deviation
27 Geometric characteristic
31 Directional error
33 Actual alignment
35 Target alignment
37 Position deviation
39 Determination of the target self-steering gradient
41 Determination of the actual steering angle
43 Lateral acceleration
45 Detection of the lateral acceleration
47 Determination of the geometric characteristic
49 Determination of an actual self-steering gradient
51 Actual self-steering gradient
53 Determination of a yaw rate
55 Yaw rate
57 Determination of a target/actual deviation
59 Target/actual deviation
61 Provision of a first limit value
63 First limit value
64 Defining of the first limit value using a load characteristic
65 Early detection of an instability
67 Indicator
69 Determination of driving data
71 Driving data
73 Analogous driving situation
75 Present vehicle configuration
77 Present vehicle speed
79 Load characteristic
81 Determination of the current vehicle speed
83 Reference steering angle
85 Reference lateral acceleration
86 Reference speed
87 Reference yaw rate
89 Determination of the target self-steering gradient from the driving data
91 Driving dynamics intervention
93 Execution of the driving dynamics intervention
95 Braking intervention
97 Progression of the actual steering angle with driving dynamics intervention
99 Reference progression of the actual steering angle without driving dynamics intervention
101 Kinematic steering angle
103 Motor torque limitation
105 Tolerance limit
107 Termination of the driving dynamics intervention
109 Determination of a steering oscillation
111 Steering oscillation
113 Natural frequency band
115 Reduction of the first limit value as a result of steering oscillation
117 Reduction of the first limit value as a result of an actual articulation angle exceeding an articulation angle tolerance value
119 Target articulation angle
121 Determination of the actual articulation angle articulation angle tolerance value
123 Determination of the target articulation angle
125 Articulation angle tolerance value
200 Driver assistance system
202 Control unit
204 Interface
300 Vehicle
302 Vehicle train
304 Towing vehicle
306 Trailer vehicle
310 Vehicle actuators
312 Steering system
314 Drive motor
316 Braking system
318 Wheels
318a, 318b Front wheel
318c Rear wheel
320 Brake actuators
322 Brake modulator
324 Vehicle network
326 Brake signals
328 Front axle
330 Foot brake module
332 Steering signals
334 Drawbar
336 Bend
338 Bend entry
340 Bend apex
342 Bend exit
344 Steering wheel
346 Front
348 Rear
350 Stability control system
352 Arrow
354 Acceleration sensor
356 Lateral acceleration signals
358 Wheelbase
359 Radius
360 Straight section
362 Center of gravity of the towing vehicle

1. A method for controlling a vehicle in a driving situation, the method comprising:
determining a target self-steering gradient of the vehicle for the driving situation;
determining an actual steering angle of the vehicle in the driving situation;
determining an actual steering gradient of the vehicle in the driving situation on a basis of the actual steering angle;
determining a target/actual deviation between the target self-steering gradient and the actual self-steering gradient;
providing a first limit value for the target/actual deviation;
early detection of instability of the vehicle when the determined target/actual deviation violates the first limit value; and,
in response to the early detection of instability of the vehicle, executing at least one vehicle dynamics intervention via at least one vehicle actuator of the vehicle to counteract the instability of the vehicle.

2. The method of claim 1, wherein said determining the target self-steering gradient of the vehicle for the driving situation includes:
determining driving data of at least one analogous driving situation; and,
determining the target self-steering gradient from the driving data.

3. The method of claim 1 further comprising at least one of:
determining a yaw rate of the vehicle in the driving situation; and,
detecting a lateral acceleration of the vehicle in the driving situation;
wherein an actual self-steering gradient of the vehicle in the driving situation is determined on the basis of the actual steering angle and at least one of the following:
i) additionally using the determined yaw rate; and,
ii) using the determined lateral acceleration.

4. The method of claim 1, further comprising:
determining at least one geometric characteristic of a current vehicle configuration of the vehicle;
wherein an actual self-steering gradient of the vehicle in the driving situation is determined on the basis of the actual steering angle additionally using the geometric characteristic of the vehicle.

5. The method of claim 1, wherein the driving dynamics intervention at least partially compensates for the instability.

6. The method of claim 5, further comprising terminating the driving dynamics intervention when the target/actual deviation reaches or falls below a tolerance limit.

7. The method of claim 1, wherein the provision of a first limit value for the target/actual deviation comprises:
determining at least one load characteristic of the current vehicle configuration; and,
defining the first limit value for the target/actual deviation using the at least one determined load characteristic.

8. The method of claim 1, wherein the driving dynamics intervention is a braking intervention on one or more brakes of the vehicle, an engine torque limitation of an engine of the vehicle, and at least one of the following:
i) a provision of asymmetrical drive torques on wheels of the vehicle; and,
ii) a provision of an assisting steering torque via a steerable auxiliary axle of the vehicle.

9. The method of claim 1, wherein, during early detection of instability of the vehicle, a determination is made as to whether the instability is understeering of the vehicle or oversteering of the vehicle in the driving situation.

10. The method of claim 1, further comprising:
determining a steering oscillation using a time history of the actual steering angle; and
in response to the determination of a steering oscillation, reducing the first limit value if a steering oscillation is determined which lies in a natural frequency band of the vehicle.

11. The method of claim 1, further comprising:
determining an actual articulation angle between a towing vehicle and a trailer vehicle of the vehicle;
determining a target articulation angle for the driving situation; and,
reducing the first limit value when the actual articulation angle exceeds the target articulation angle by an articulation angle tolerance value.

12. The method of claim 1, further comprising:
determining a current vehicle speed of the vehicle in the driving situation; and,
wherein providing a first limit value for the target/actual deviation comprises defining the first limit value at least using the determined vehicle speed, wherein the first limit value is indirectly proportional to the vehicle speed.

13. A driver assistance system for improving a trajectory orientation of a vehicle in a driving situation, the driver assistance system comprising a control unit configured to carry out a method for controlling the vehicle in a driving situation, the method including the steps of:
determining a target self-steering gradient of the vehicle for the driving situation;
determining an actual steering angle of the vehicle in the driving situation;
determining an actual steering gradient of the vehicle in the driving situation on a basis of the actual steering angle;
determining a target/actual deviation between the target self-steering gradient and the actual self-steering gradient;
providing a first limit value for the target/actual deviation;
early detection of instability of the vehicle when the determined target/actual deviation violates the first limit value; and,
in response to the early detection of instability of the vehicle, executing at least one vehicle dynamics intervention via at least one vehicle actuator of the vehicle to counteract the instability of the vehicle.

14. A vehicle having at least two axles, comprising a driver assistance system as claimed in claim 13.

15. A computer program product comprising:
a program code stored on a non-transitory computer-readable medium;
said program code being configured, when executed by a processor, to:
determine a target self-steering gradient of the vehicle for the driving situation;
determine an actual steering angle of the vehicle in the driving situation;
determine an actual steering gradient of the vehicle in the driving situation on a basis of the actual steering angle;
determine a target/actual deviation between the target self-steering gradient and the actual self-steering gradient;
provide a first limit value for the target/actual deviation;
early detect instability of the vehicle when the determined target/actual deviation violates the first limit value; and,
in response to the early detection of instability of the vehicle, execute at least one vehicle dynamics intervention via at least one vehicle actuator of the vehicle to counteract the instability of the vehicle.
